(19) United States
(12) Patent Application Publication
(10) Pub. No.: US 2008/0216476 A1
(43) Pub. Date: Sep. 11, 2008

(54) TURBOCHARGED INTERNAL COMBUSTION ENGINE WITH EGR SYSTEM HAVING REVERSE FLOW

(75) Inventor: Matthew Ryan Evers, Evansdale, IA (US)

Correspondence Address: Taylor & Aust, P.C/Deere & Company, P.O. Box 560, Avilla, IN, 46710, US

(73) Assignee: Deere & Company

(21) Appl. No.: 12/117,110

(22) Filed: May 8, 2008

Related U.S. Application Data
(63) Continuation of application No. 11/242,100, filed on Oct. 3, 2005.

(51) Int. Cl. F02B 33/44

(52) U.S. Cl. 60/605.2; 60/611

(57) ABSTRACT

An internal combustion engine includes a block defining at least one combustion cylinder. An intake manifold is fluidly coupled with at least one combustion cylinder, and an exhaust manifold is also fluidly coupled with at least one combustion cylinder. An exhaust gas recirculation system is fluidly coupled between the exhaust manifold and the intake manifold. A turbocharger includes a variable geometry turbine fluidly coupled with the exhaust manifold. The variable geometry turbine is movable to a first position effecting fluid flow of exhaust gas from the exhaust manifold to the intake manifold, and movable to a second position effecting fluid flow of charge air to the variable geometry turbine.

### CROSS REFERENCE TO RELATED APPLICATIONS

This is a continuation of U.S. patent application Ser. No. 11/242,100 entitled “TURBOCHARGED INTERNAL COMBUSTION ENGINE WITH EGR SYSTEM HAVING REVERSE FLOW”, filed Oct. 3, 2005.

### FIELD OF THE INVENTION

The present invention relates to internal combustion engines, and, more particularly, to exhaust gas recirculation systems in such engines.

### BACKGROUND OF THE INVENTION

An internal combustion (IC) engine may include an exhaust gas recirculation (EGR) system for controlling the generation of undesirable pollutant gases and particulate matter in the operation of internal combustion engines. EGR systems primarily recirculate the exhaust gas by-products into the intake air supply of the internal combustion engine. The exhaust gas which is reintroduced to the engine cylinder reduces the concentration of oxygen therein, which in turn lowers the maximum combustion temperature within the cylinder and slows the chemical reaction of the combustion process, decreasing the formation of nitrous oxides (NOx). Furthermore, the exhaust gases typically contain unburned hydrocarbons which are burned on reintroduction into the engine cylinder, which further reduces the emission of exhaust gas by-products which would be emitted as undesirable pollutants from the IC engine.

An IC engine may also include one or more turbochargers for compressing a fluid which is supplied to one or more combustion chambers within corresponding combustion cylinders. Each turbocharger typically includes a turbine driven by exhaust gases of the engine and a compressor which is driven by the turbine. The compressor receives the fluid to be compressed and supplies the fluid to the combustion chambers. The fluid which is compressed by the compressor may be in the form of combustion air or a fuel and air mixture.

The operating behavior of a compressor within a turbocharger may be graphically illustrated by a “compressor map” associated with the turbocharger in which the pressure ratio (compression outlet pressure divided by the inlet pressure) is plotted on the vertical axes and the flow rate is plotted on the horizontal axes. In general, the operating behavior of a compressor is limited on the left side of the compressor map by a “surge line” and on the right side of the compressor map by a “choke line”. The surge line basically represents “stalling” of the air flow at the compressor inlet. With too small a volume flow and too high a pressure ratio, the flow will separate from the suction side of the blades on the compressor wheel, with the result that the discharge process is interrupted. The air flow through the compressor is reversed until a stable pressure ratio by positive volumetric flow rate is established, the pressure builds up again and the cycle repeats. This flow instability continues at a substantially fixed frequency and the resulting behavior is known as “surging”. The choke line represents the maximum centrifugal compressor volumetric flow rate, which is limited for instance by the cross-section at the compressor inlet. When the flow rate at the compressor inlet or other location reaches sonic velocity, no further flow rate increase is possible and choking results. Both surge and choking of a turbocharger compressor should be avoided.

When utilizing EGR in a turbocharged diesel engine, the exhaust gas to be recirculated is preferably removed upstream of the exhaust gas driven turbine associated with the turbocharger. In many EGR applications, the exhaust gas is diverted by a poppet-type EGR valve directly from the exhaust manifold. The percentage of the total exhaust flow which is diverted for introduction into the intake manifold of an internal combustion engine is known as the EGR rate of the engine.

### SUMMARY OF THE INVENTION

The present invention provides an EGR system which is configured such that exhaust gas is circulated to the intake manifold, or, alternatively, charge air is bypassed in a reverse direction through the EGR system to the turbocharger.

The invention comprises, in one form thereof, an internal combustion engine including a block defining at least one combustion cylinder. An intake manifold is fluidly coupled with at least one combustion cylinder, and an exhaust manifold is also fluidly coupled with at least one combustion cylinder. An exhaust gas recirculation system is fluidly coupled between the exhaust manifold and the intake manifold. A turbocharger includes a variable geometry turbine fluidly coupled with the exhaust manifold. The variable geometry turbine is movable to a first position effecting fluid flow of exhaust gas from the exhaust manifold to the intake manifold, and movable to a second position effecting fluid flow of charge air to the variable geometry turbine.

The invention comprises, in another form thereof, an exhaust gas recirculation system for an internal combustion engine including an intake manifold having an inlet, an exhaust manifold having an outlet, and a turbocharger coupled with the exhaust manifold outlet. The exhaust gas recirculation system includes at least one fluid line for interconnecting the exhaust manifold outlet and the intake manifold inlet; and a pressure differential generator for selectively generating an EGR flow of exhaust gas through the at least one fluid line from the exhaust manifold outlet to the intake manifold inlet, and a reverse EGR flow of charge air through the at least one fluid line to the turbocharger.

### BRIEF DESCRIPTION OF THE DRAWINGS

FIG. 1 is a schematic illustration of an embodiment of an internal combustion engine of the present invention; and

FIG. 2 is a graphical illustration of a compressor map for the turbocharger shown in FIG. 1, illustrating the effect of the present invention on the compressor map.

### DESCRIPTION OF THE PREFERRED EMBODIMENT

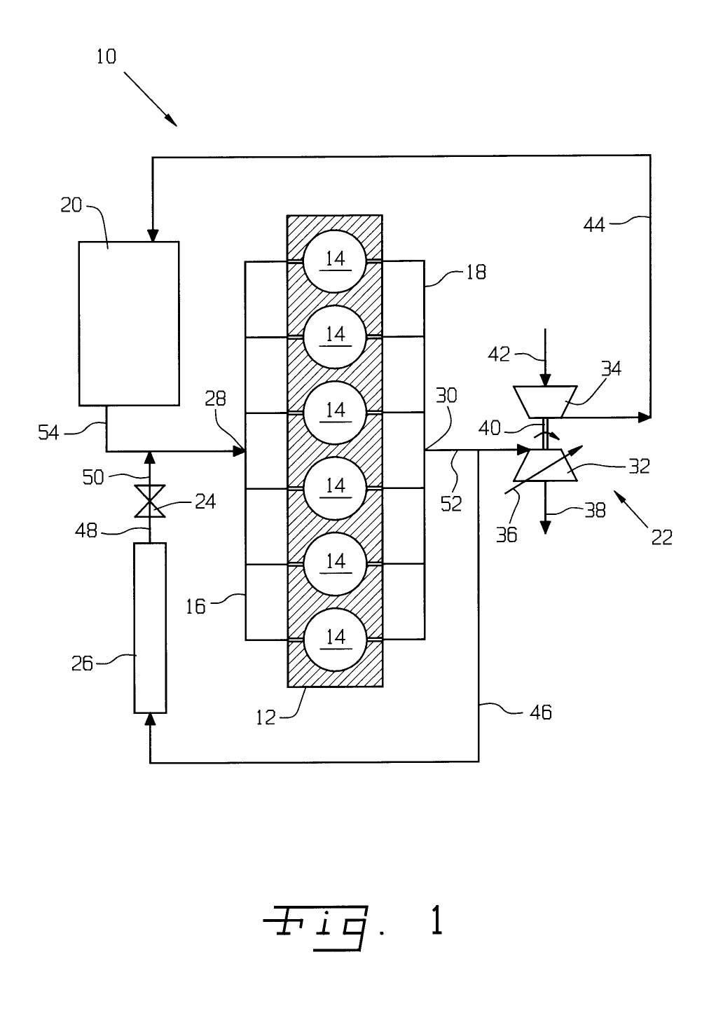

Referring now to the drawings, and more particularly to FIG. 1, there is shown an embodiment of an IC engine 10 of the present invention, which generally includes a block 12 having a plurality of combustion cylinders 14, intake manifold 16, exhaust manifold 18, charge air cooler 20, turbocharger 22, EGR valve 24 and EGR cooler 26. In the embodiment shown, IC engine 10 is a diesel engine which is incorporated into a work machine, such as an agricultural tractor or combine, but may be differently configured, depending upon the application.

Block 12 is typically a cast metal block which is formed to define combustion cylinders 14. In the embodiment shown, block 12 includes six combustion cylinders 14, but may include a different number depending upon the application. Intake manifold 16 and exhaust manifold 18 are also typically formed from cast metal, and are coupled with block 12 in conventional manner, such as by using bolts and gaskets. Intake manifold 16 and exhaust manifold 18 are each in fluid communication with combustion cylinders 14. Intake manifold 16 receives charge air from charge air cooler 20 at intake manifold inlet 28, and supplies charge air (which may be air or a fuel/air mixture) to combustion cylinders 14, such as by using fuel injectors (not shown).

Similarly, exhaust manifold 18 is in fluid communication with combustion cylinders 14, and includes an outlet 30 from which exhaust gas from combustion cylinders 14 is discharged to turbocharger 22.

Turbocharger 22 includes a variable geometry turbine (VGT) 32 and a compressor 34. VGT 32 is adjustably controllable as indicated by line 36, and includes an actuatable element which is controlled electronically using a controller (not shown). For example, VGT 32 may be actuated by changing the position of turbine blades, a variable size orifice, or other actuatable elements. The turbine within VGT 32 is driven by exhaust gas from exhaust manifold 18, and is exhausted to the environment, as indicated by arrow 38.

VGT 32 mechanically drives compressor 34 through a rotatable shaft 40. Compressor 34 is a fixed geometry compressor in the embodiment shown. Compressor 34 receives combustion air from the ambient environment as indicated by line 42, and discharges the compressed combustion air via line 44 to charge air cooler 20. As a result of the mechanical work through the compression of the combustion air, the heated charge air is cooled in charge air cooler 20 prior to being introduced at inlet 28 of intake manifold 16.

EGR valve 24 and EGR cooler 26 are part of an EGR system which also includes a first fluid line 46, second fluid line 48 and third fluid line 50. The term fluid line, as used herein, is intended broadly to cover a conduit for transporting a gas such as exhaust gas and/or combustion air, as will be understood hereinafter.

First fluid line 46 is coupled at one end thereof with a fluid line 52 interconnecting exhaust manifold outlet 30 with VGT 32. First fluid line 46 is coupled at an opposite end thereof with EGR cooler 26. Second fluid line 48 fluidly interconnects EGR cooler 26 with EGR valve 24. Third fluid line 50 fluidly interconnects EGR valve 24 with fluid line 54 extending between charge air cooler 20 and inlet 28 of intake manifold 16.

In the embodiment shown in FIG. 1, first fluid line 46 is fluidly coupled with fluid line 52 extending between exhaust manifold 18 and VGT 32. However, it will also be understood that first fluid line 46 may be fluidly coupled directly with exhaust manifold 18 for certain applications. Similarly, third fluid line 50 is fluidly coupled with fluid line 54 interconnecting charge air cooler 20 and inlet 28 of intake air manifold 16. However, it will also be understood that third fluid line 50 may be coupled directly with intake air manifold 16 in certain applications.

During operation, IC engine 10 is operated to recirculate a selective amount of exhaust gas from exhaust manifold 18 to intake manifold 16 using an EGR system defined by first fluid line 46, EGR cooler 26, second fluid line 48, EGR valve 24 and third fluid line 50. The EGR system could also be defined by first fluid line 46, EGR valve 24, second fluid line 48, EGR cooler 26, and third fluid line 50, in that order connecting fluid line 52 to fluid line 54. A controller selectively actuates EGR valve 24 to provide EGR flow of the exhaust gas in the EGR flow direction indicated by the large directional arrows on first fluid line 46 and third fluid line 50.

Conversely, the EGR system is also configured to provide a reverse flow of fluid in the form of charge air from fluid line 54 to fluid line 52 leading to VGT 32. More particularly, VGT 32 may be controllably actuated to provide a pressure within fluid line 52 which is less than the pressure within fluid line 54. When EGR valve 24 is opened, charge air thus flows from fluid line 54 through EGR valve 24 and EGR cooler 26 to fluid line 52, and ultimately to VGT 32. Under certain operating conditions, it is desirable to mix cooled charge air with the exhaust which is discharged from outlet 30 of exhaust manifold 18. The reverse flow direction of charge air through the EGR system is indicated by the smaller directional arrows on second fluid line 48 and first fluid line 46.

Conventional operation of an EGR system deactivates the EGR system, or prevents any through flow, during engine operating conditions when no EGR flow is desired. On the other hand, the present invention utilizes an EGR system in a reverse flow mode to bypass fresh air around combustion cylinders 14 to VGT 32 during appropriate engine operating conditions when no EGR flow is desired. For this reverse flow to occur, it is apparent that VGT 32 is configured in a way to obtain a positive engine delta pressure (higher intake manifold pressure than exhaust manifold pressure). The process of configuring the turbocharger to obtain a positive engine delta pressure also allows a more efficient operation of turbocharger 22.

The present invention has been shown to provide improved fuel efficiency, air to fuel ratio, smoke emissions, and compressor surge margin, as well as reduce exhaust temperatures, at low to intermediate engine speeds when IC engine 10 is delivering moderate to high torque output. Due to these engine performance improvements, maximum engine output torque at certain engine speeds can also be increased, if desired.

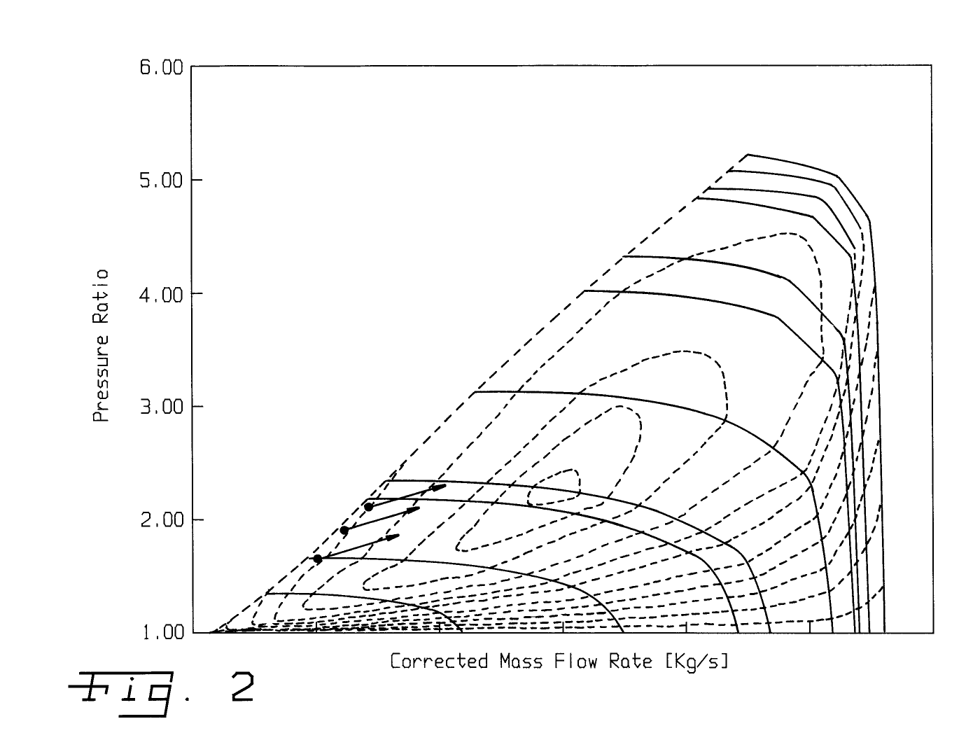

FIG. 2 is a graphical illustration of a compressor map for compressor 34 of turbocharger 22 when using EGR reverse flow of the present invention as described above. The left most line on the curve represents the surge line of the compressor. Using EGR reverse flow with the present invention, the operating point is shifted upward and to the right away from the surge line, as indicated by any particular one of the three arrows. This effectively reduces the possibility of surge of compressor 34 of turbocharger 22.

In the embodiment of the present invention described above, IC engine 10 includes a VGT 32 which is controlled to provide a delta engine pressure between intake manifold 16 and exhaust manifold 18 allowing reverse flow through the EGR system. However, it is also possible to use a pressure differential generator in the form of a differently configured turbocharger, such as a turbocharger with a wastegate, a multiple turbocharger system, a multi-stage turbocharger system, or even a fixed geometry turbocharger at low engine speeds.

Having described the preferred embodiment, it will become apparent that various modifications can be made without departing from the scope of the invention as defined in the accompanying claims.

1. A method of operating an air-breathing, fuel consuming internal combustion engine having a variable geometry turbocharger turbine having an inlet and receiving products of combustion from said engine and driving a turbocharger compressor having an outlet and delivering pressurized air to the internal combustion engine, the engine having an exhaust gas recirculation (EGR) line connecting from upstream of the turbocharger turbine inlet and to downstream of the turbocharger compressor outlet and having a valve selectively permitting flow through said line, said method comprising the steps of:
selectively operating the valve and the variable geometry turbocharger turbine when EGR flow is desired to produce EGR flow through said line to said internal combustion engine; and
selectively operating the variable geometry turbocharger turbine and valve when EGR flow is not desired to reduce the pressure upstream of the turbocharger turbine inlet to produce bypass flow through said line from downstream of the turbocharger compressor outlet to upstream of the turbocharger turbine inlet.

2. A method as claimed in claim 1 wherein the turbocharger compressor operates over a compressor map, delimited on one side by a surge line and said bypass flow from downstream of the turbocharger compressor outlet to upstream of the turbocharger turbine inlet moves the operating point of the turbocharger compressor away from said surge line.

3. A method as claimed in claim 1 wherein the variable geometry turbocharger turbine is moved to a more open position to reduce pressure upstream of the turbocharger turbine inlet to produce bypass flow around the engine.
